(19) United States
(12) Patent Application Publication
(10) Pub. No.: US 2026/0209079 A1
(43) Pub. Date: Jul. 23, 2026

(54) METHOD FOR ADSORPTION AND IMMOBILIZATION OF HEAVY METAL ION IN WATER AND GEOPOLYMER CEMENTITIOUS MATERIAL

(71) Applicant: GuangZhou University, Guangzhou (CN)

(72) Inventors: Yuwei MA, Guangzhou (CN); Yunpeng TAN, Guangzhou (CN); Xiaowei OUYANG, Guangzhou (CN); Zongjin LI, Guangzhou (CN); Jiyang FU, Guangzhou (CN)

(73) Assignee: GuangZhou University, Guangzhou (CN)

(21) Appl. No.: 19/450,791

(22) Filed: Jan. 16, 2026

(30) Foreign Application Priority Data
Jan. 17, 2025 (CN) 2025100819020

(51) Int. Cl. C02F 1/28; C02F 101/20; C04B 12/00

(52) U.S. Cl. CPC C02F 1/281; C04B 12/005; C02F 2101/20

(57) ABSTRACT

The present invention discloses a method for adsorption and immobilization of a heavy metal ion in water and a method for preparing a geopolymer cementitious material, and belongs to the fields of environmental protection engineering and materials engineering. The method for adsorption and immobilization of a heavy metal ion in water includes the following steps: adsorbing a heavy metal ion in water using carbonized micropowder; mixing the carbonized micropowder after adsorbing the heavy metal ion with one or more of granulated blast furnace slag, gypsum, and steel slag to obtain a solid material; and mixing the solid material with an alkaline activator, followed by curing and molding. According to the present invention, a solidification amount of heavy metals can be significantly increased. Meanwhile, a prepared geopolymer has excellent mechanical performance, can be used as a low-cost green building material or for fields such as solid waste landfill.

### CROSS-REFERENCE TO RELATED APPLICATIONS

The application claims priority to Chinese patent application No. 2025100819020, filed on Jan. 17, 2025, the entire contents of which are incorporated herein by reference.

### TECHNICAL FIELD

The present invention relates to the fields of environmental protection engineering and materials engineering, and particularly relates to a method for adsorption and immobilization of a heavy metal ion in water and a geopolymer cementitious material.

### BACKGROUND

Over the past 30 years, the heavy metal industry has undergone rapid expansion. Due to improper use and excessive use of industrial manufacturing, mining, and domestic and industrial wastewater, a large amount of heavy metal waste has been discharged into the environment, posing a serious threat to human health and the living environment, which has become a highly challenging environmental problem.

Solidification/stabilization (S/S) technology has been widely demonstrated as an efficient, rapid, and economical method for treatment of heavy metals. Traditional Portland cement is a good solidifying agent and a binder. However, the production of Portland cement generates large amounts of carbon dioxide emissions and energy consumption, thereby exacerbating the greenhouse effect. Similar to the Portland cement, geopolymers (geological polymers) also exhibit an excellent immobilization capability for heavy metal ions, and the production of geopolymers utilizes solid waste materials, thus having a lower cost without exacerbating the greenhouse effect. According to Han Fenglan et al., in “Solidification/stabilization mechanism of Pb(II), Cd(II), Mn(II) and Cr(III) in fly ash based geopolymers” (Construction and Building Materials, 2018, 160: 818-827), a geopolymer is prepared under alkaline activation conditions with fly ash as a raw material and is used for solidification of heavy metal Pb²⁺, Cd²⁺, Mn²⁺, and Cr³⁺. The study shows that when the doping amounts of Pb²⁺, Cd²⁺, Mn²⁺, and Cr³⁺ are 1.5 wt %, its solidification efficiency reaches 99.92-99.98%, and a 28-day compressive strength of a sample is up to 49.34 MPa. According to Ji Zehua et al., in “Immobilization efficiency and mechanism of metal cations (Cd²⁺, Pb²⁺ and Zn²⁺) and anions (AsO₄³⁻ and Cr₂O₇²⁻) in wastes-based geopolymer” (Journal of Hazardous Materials, 2020, 384: 121290), a geopolymer is prepared under alkaline activation conditions with drinking water treatment residue (DWTR) and granulated blast furnace slag (GBFS) as main raw materials and is used for solidification of Cd²⁺, Pb²⁺, and Zn²⁺. Study results show that when the doping amounts of Cd²⁺, Pb²⁺, and Zn²⁺ are below 4 wt %, its solidification efficiency reaches 92.34%-100%, and a 7-day compressive strength of a sample is up to 16 MPa. Existing studies show that alkali-based geopolymers have high efficiency in the aspect of solidifying heavy metal ions. However, the maximum concentrations of heavy metal ions that can be solidified are generally low, and are usually only limited to 0.5 wt % to 4 wt %. When the doping amounts of heavy metal ions are high, an alkaline activation reaction process is severely impeded, resulting in poor fluidity, which limits their applications in the treatment of high-concentration heavy metal pollution.

In another aspect, a resource utilization rate of construction waste in China is currently only 5%, and most of construction solid waste is directly discarded or landfilled. Waste concrete, as a main ingredient of the construction waste, generates waste concrete micropowder with a particle size of less than 0.15 mm during a recycling process, which is still mainly used for landfill or as a filling material and has not been effectively utilized. The waste concrete micropowder contains large amounts of hydration products such as calcium silicate hydrate, and these mineral components have high carbonization activity and can react with CO₂ to reconstruct the mineral components and generate substances such as calcium carbonate, an amorphous silica gel, and an alumina gel. A carbonized micropowder product can be used for effective adsorption and removal of heavy metal ions in wastewater, and the carbonized micropowder containing adsorbed heavy metals is further solidified by an alkaline activation technology.

### SUMMARY

To address the above problems, the present invention adopts a solidification/stabilization technology of geopolymers and provides a method for adsorption and immobilization of a heavy metal ion in water and a geopolymer cementitious material to achieve efficient adsorption and immobilization of high-concentration heavy metal pollution wastewater and meanwhile prepare the geopolymer cementitious material with high compressive strength, which has a low preparation cost, is low-carbon and environmentally friendly, and can be widely applied in fields such as solid waste landfill.

The objectives of the present invention are achieved by adopting the following technical solutions.

A method for adsorption and immobilization of a heavy metal ion in water includes the following steps:
(1) adsorbing a heavy metal ion in water using carbonized micropowder, where the carbonized micropowder is obtained by carbonizing concrete micropowder in a carbon dioxide atmosphere, and the concrete micropowder is obtained by grinding hydrated cement, for example, grinding cement after natural curing and molding into powder, for another example, grinding waste concrete into powder, and for another example, grinding waste concrete with a coarse aggregate and/or a fine aggregate into powder;
(2) mixing the carbonized micropowder after adsorbing the heavy metal ion with one or more of granulated blast furnace slag, gypsum, and steel slag to obtain a solid material; and
(3) mixing the solid material with an alkaline activator, followed by curing and molding.

In some preferred embodiments, the heavy metal ion is one or more of a lead ion, a zinc ion, and a copper ion.

In some preferred embodiments, the concrete micropowder has a particle size of less than 125 μm.

In some preferred embodiments, in percentage by weight, the concrete micropowder has a CaO content of not less than 48.28%, a SiO₂ content of not less than 15.27%, and an Al₂O₃ content of not less than 4.32%.

In some preferred embodiments, conditions for the carbonizing are as follows: a humidity of 70±3%, a temperature of 20±2° C., a carbon dioxide concentration of 20±3%, and a carbonizing time of 7 days.

In some preferred embodiments, the granulated blast furnace slag is S95 grade slag with a median particle size D50 of 12.06 μm.

In some preferred embodiments, a mass proportion of the carbonized micropowder after adsorbing the heavy metal ion in the solid material is 30-70%.

In some preferred embodiments, the alkaline activator includes a mixture of a sodium hydroxide solution and sodium silicate, and has a modulus of 1-2 and a Na₂O content of 3-6 wt %.

In some preferred embodiments, a water-cement ratio of the solid material to the alkaline activator is 0.38-0.45.

In some preferred embodiments, the curing in the step (3) is performed at a temperature of 20±2° C. and a relative humidity of >95%.

Another objective of the present invention is to provide a geopolymer cementitious material, where the geopolymer cementitious material is prepared by the aforementioned adsorption and immobilization method.

Beneficial effects of the present invention are as follows.

According to the present invention, the carbonized concrete micropowder with a huge adsorption capacity is utilized to first adsorb the heavy metal ion in wastewater and then react with the slag and other precursors by utilizing its higher alkaline activation activity to generate a cementitious material with a three-dimensional cross-linked structure, thereby providing superior structural strength for a geopolymer. During this process, a large number of heavy metals are introduced into a geopolymer system, and the heavy metal ion can form a certain special phase in a matrix phase through a certain chemical bond generated with an aluminosilicate framework during the formation of a geopolymer structure. Furthermore, a gel network of the geopolymer has good compatibility, which enables the heavy metals and their resulting precipitates to be stably embedded in its microstructure, thereby effectively limiting the mobility of the heavy metals and the possibility of secondary reactions, and enhancing the environmental durability and safety of the material. According to the present invention, a geopolymer solidified body after solidification of heavy metals has excellent mechanical performance and can solidify higher contents of heavy metals, with leaching concentrations of various heavy metals far below limit values, thereby reducing the environmental diffusion of heavy metals. According to the present invention, by utilizing industrial by-products, demands for expensive adsorption materials and waste treatment costs are effectively reduced, and meanwhile waste can be converted into valuable construction materials, thereby reducing energy consumption and carbon emissions during the production of new materials, satisfying the standards of environmental protection and sustainable development, and enhancing environmental sustainability.

### BRIEF DESCRIPTION OF DRAWINGS

The present invention is further described with reference to the drawings, but the examples in the drawings do not constitute any limitation to the present invention. For those of ordinary skill in the art, other drawings can also be obtained based on the following drawings without exerting creative labor.

FIG. 1 is a flow chart of a method for adsorption and solidification of a heavy metal ion in wastewater according to the present invention;

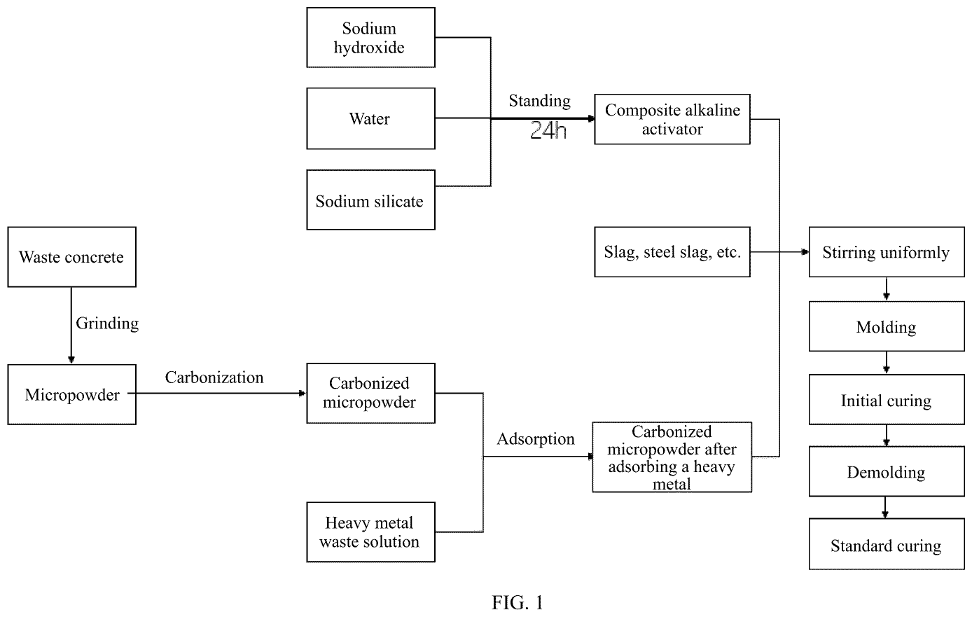

FIG. 2 shows unconfined compressive strength results of a geopolymer cementitious material specimen prepared in Example 1 of the present invention;

FIG. 3 shows unconfined compressive strength results of a geopolymer cementitious material specimen prepared in Example 2 of the present invention;

FIG. 4 shows unconfined compressive strength results of a geopolymer cementitious material specimen prepared in Example 3 of the present invention;

FIG. 5 shows toxicity leaching results of the geopolymer cementitious material specimen prepared in Example 1 of the present invention;

FIG. 6 shows toxicity leaching results of the geopolymer cementitious material specimen prepared in Example 2 of the present invention;

FIG. 7 shows toxicity leaching results of the geopolymer cementitious material specimen prepared in Example 3 of the present invention;

FIG. 8 shows toxicity leaching results of a geopolymer cementitious material specimen prepared in Comparative Example 1 of the present invention;

FIG. 9 shows unconfined compressive strength results of a geopolymer cementitious material specimen prepared in Comparative Example 2 of the present invention;

FIG. 10 shows toxicity leaching results of the geopolymer cementitious material specimen prepared in Comparative Example 2 of the present invention; and

FIG. 11 shows unconfined compressive strength results of a geopolymer cementitious material specimen prepared in Comparative Example 3 of the present invention.

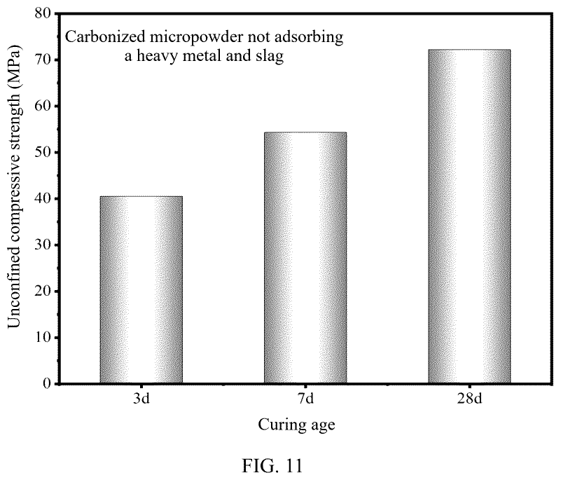

### DETAILED DESCRIPTION OF THE EMBODIMENTS

The present invention is further described in conjunction with the following examples.

### Example 1

This example relates to a method for adsorption and solidification of a heavy metal ion in wastewater, and meanwhile also relates to a method for preparing a geopolymer cementitious material. The method for adsorption and solidification of heavy metal ions in wastewater includes steps as follows.
(1) Cement naturally cured for 7 days was ground in a ball mill to a particle size of less than 125 μm to obtain concrete micropowder, where the concrete micropowder had a CaO content of 48.28%, a SiO₂ content of 15.27%, and an Al₂O₃ content of 4.32%; then, the concrete micropowder was carbonized under conditions of a humidity of 70±3%, a temperature of 20±2° C., and a carbon dioxide concentration of 20±3% for 7 days, where after the carbonization, the grayish-white concrete micropowder turned into pure gray carbonized concrete micropowder; the carbonized concrete micropowder and lead-containing wastewater were added into a glass container at a ratio of 10 g:1 L, with a concentration of a lead ion in the wastewater at 1,600 mg/L; the mixture was shaken in a shaker at 25° C. and 200 rpm for 10 minutes, and then filtered using a 30 μm polypropylene (PP) filter membrane in a vacuum filtration device to obtain powder and treated wastewater; the carbonized concrete micropowder after adsorbing the lead ion obtained after the filtration was oven-dried in an oven at 60° C. for 4 hours; and the treated wastewater was used for testing the concentration of the heavy metal ion.
(2) Water, NaOH, and sodium silicate were mixed to formulate an alkaline activator with a modulus of 1.2 and a Na₂O content of 5%, followed by standing for 24 hours for later use; the dried carbonized concrete micropowder after adsorbing the lead ion in the step (1) and granulated blast furnace slag were added in equal weight (50%:50%, theoretically, heavy metals accounted for about 7% of a mass of ash) into a cement paste mixer and mixed by stirring to obtain a solid material; subsequently, the alkaline activator was added at a water-cement ratio of 0.4 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

The granulated blast furnace slag is S95 grade slag, with main components of CaO (40.03%), SiO₂ (33.58%), and Al₂O₃ (14.59%).

### Example 2

This example relates to a method for adsorption and solidification of a heavy metal ion in wastewater, and meanwhile also relates to a method for preparing a geopolymer cementitious material. The method for adsorption and solidification of heavy metal ions in wastewater includes steps as follows.
(1) Cement naturally cured for 7 days was ground in a ball mill to a particle size of less than 125 μm to obtain concrete micropowder, where the concrete micropowder had a CaO content of 48.28%, a SiO₂ content of 15.27%, and an Al₂O₃ content of 4.32%; then, the concrete micropowder was carbonized under conditions of a humidity of 70±3%, a temperature of 20±2° C., and a carbon dioxide concentration of 20±3% for 7 days, where after the carbonization, the grayish-white concrete micropowder turned into pure gray carbonized concrete micropowder; the carbonized concrete micropowder and lead-containing wastewater were added into a glass container at a ratio of 10 g:1 L, with a concentration of a lead ion in the wastewater at 2,000 mg/L; the mixture was shaken in a shaker at 25° C. and 200 rpm for 10 minutes, and then filtered using a 30 μm polypropylene (PP) filter membrane in a vacuum filtration device to obtain powder and treated wastewater; the carbonized concrete micropowder after adsorbing the lead ion obtained after the filtration was oven-dried in an oven at 60° C. for 4 hours; and the treated wastewater was used for testing the concentration of the heavy metal ion.
(2) Water, NaOH, and sodium silicate were mixed to formulate an alkaline activator with a modulus of 1.2 and a Na₂O content of 4%, followed by standing for 24 hours for later use; the dried carbonized concrete micropowder after adsorbing the lead ion in the step (1) and granulated blast furnace slag were added in equal weight (50%:50%, theoretically, heavy metals accounted for about 8.5% of a mass of ash) into a cement paste mixer and mixed by stirring to obtain a solid material; subsequently, the alkaline activator was added at a water-cement ratio of 0.45 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

The granulated blast furnace slag is S95 grade slag, with main components of CaO (40.03%), SiO₂ (33.58%), and Al₂O₃ (14.59%).

### Example 3

This example relates to a method for adsorption and solidification of a heavy metal ion in wastewater, and meanwhile also relates to a method for preparing a geopolymer cementitious material. The method for adsorption and solidification of heavy metal ions in wastewater includes steps as follows.
(1) Cement naturally cured for 7 days was ground in a ball mill to a particle size of less than 125 μm to obtain concrete micropowder, where the concrete micropowder had a CaO content of 48.28%, a SiO₂ content of 15.27%, and an Al₂O₃ content of 4.32%; then, the concrete micropowder was carbonized under conditions of a humidity of 70±3%, a temperature of 20±2° C., and a carbon dioxide concentration of 20±3% for 7 days, where after the carbonization, the grayish-white concrete micropowder turned into pure gray carbonized concrete micropowder; the carbonized concrete micropowder and lead-containing wastewater were added into a glass container at a ratio of 10 g:1 L, with a concentration of a lead ion in the wastewater at 2,000 mg/L; the mixture was shaken in a shaker at 25° C. and 200 rpm for 10 minutes, and then filtered using a 30 μm polypropylene (PP) filter membrane in a vacuum filtration device to obtain powder and treated wastewater; the carbonized concrete micropowder after adsorbing the lead ion obtained after the filtration was oven-dried in an oven at 60° C. for 4 hours; and the treated wastewater was used for testing the concentration of the heavy metal ion.
(2) Water, NaOH, and sodium silicate were mixed to formulate an alkaline activator with a modulus of 1.2 and a Na₂O content of 4%, followed by standing for 24 hours for later use; the dried carbonized concrete micropowder after adsorbing the lead ion in the step (1), granulated blast furnace slag, and gypsum were added at a mass ratio of 2:7:1 (theoretically, heavy metals accounted for about 3.33% of a mass of ash) into a cement paste mixer and mixed by stirring to obtain a solid material; subsequently, the alkaline activator was added at a water-cement ratio of 0.4 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

The granulated blast furnace slag is S95 grade slag, with main components of CaO (40.03%), SiO₂ (33.58%), and Al₂O₃ (14.59%).

The gypsum is phosphogypsum, with main components of CaO (38.26%), SiO₂ (7.52%), and SO₃ (49.17%).

### Performance Tests

### 1. Adsorption Capacity

Pb(NO₃)₂ (160 mg/200 mg) was added into 100 mL of deionized water to simulate heavy metal wastewater, the mixture was shaken in a shaker at 25° C. and 200 rpm for 10 minutes and then filtered using a 30 μm polypropylene (PP) filter membrane in a vacuum filtration device to obtain powder and treated wastewater, and the treated wastewater was analyzed by inductively coupled plasma optical emission spectrometry (ICP-OES) to test the concentration of Pb²⁺. A calculation formula for an adsorption capacity of a heavy metal ion (Qₑ) is as follows:

$${Q}_{e} = \frac{( {C}_{0} - {C}_{e} ) V}{m}$$

where Qₑ represents an average adsorption capacity (mg/g); C₀ and Cₑ respectively represent an initial concentration of the heavy metal ion and an equilibrium concentration of the heavy metal ion (mg/L); and V represents a solution volume (L), and m represents a mass of CRP (g).

A calculation formula for an adsorption efficiency Ae (%) is as follows:

$$Ae ( \% ) = \frac{{C}_{0} - {C}_{e}}{{C}_{0}}$$

where C₀ and Cₑ respectively represent an initial concentration of the heavy metal ion and an equilibrium concentration of the heavy metal ion (mg/L).

### 2. Compressive Strength

The geopolymer material specimens prepared and cured to specified ages under standard conditions in examples were placed on a test platform of a constant-load cement bending compression testing machine, at a contact area of 400 mm² and a loading rate of 0.1 mm/min until solidified bodies failed. The compressive strength of a solidified body is P (MPa)=F/A, where F represents a failure peak load, and A represents a compression area. A compressive strength test is performed 3 times in parallel, and a mean value is obtained.

### 3. Toxicity Leaching

After curing for 3 days, 7 days, and 28 days, the specimens were pulverized and sieved to collect powder with a particle size of less than 200 μm. 2 g of the powder was weighed, added into 40 mL of an acetic acid buffer extractant, placed in a 100 mL polyethylene flask to make sure that a flask mouth was sealed, and then placed in a constant temperature shaker for shaking at a rotation speed of 120 rpm and a temperature of 24±1° C. for 18 hours. Subsequently, the mixture was filtered through a 0.45 μm filter membrane using a syringe filter. A supernatant was collected in a test tube. After the filtration, a filtrate was treated with concentrated nitric acid to lower a pH value below 2.0, and the concentration of heavy metals in a leachate was measured by inductively coupled plasma optical emission spectrometry (ICP-OES).

A method for preparing the acetic acid buffer extractant includes: adding 5.7 mL of glacial acetic acid into deionized water, mixing uniformly, then reaching a constant volume of 1 L, and adjusting a solution pH value to 2.88±0.05.

### Test Results

(1) The adsorption capacity and adsorption efficiency of the adsorption and solidification methods in Examples 1-2 are shown in Table 1.

TABLE 1
Adsorption capacity and adsorption efficiency of Examples 1-2

| Initial | Equilibrium ion | Adsorption | Adsorption |
|---|---|---|---|
| concentration | concentration | capacity Qₑ | efficiency |
| C₀ (mg/L) | Cₑ (mg/L) | (mg/g) | (%) |
| 1600 | 0.08 | 159.992 | 99.99 |
| 2000 | 1.22 | 199.878 | 99.99 |

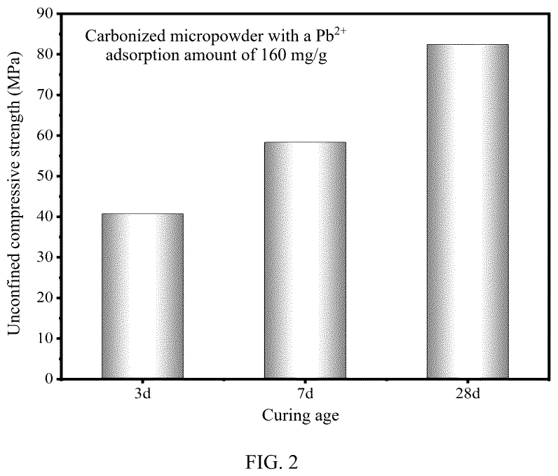

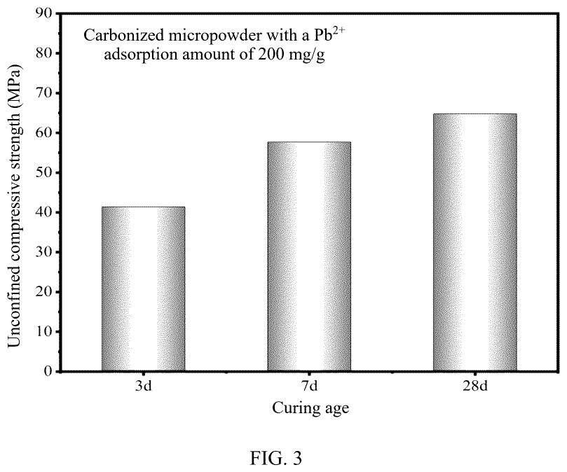

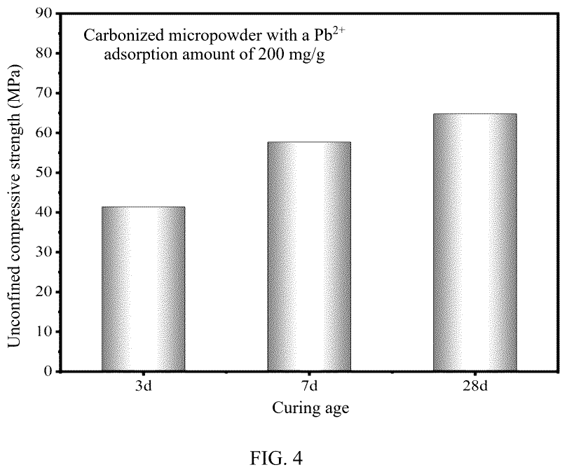

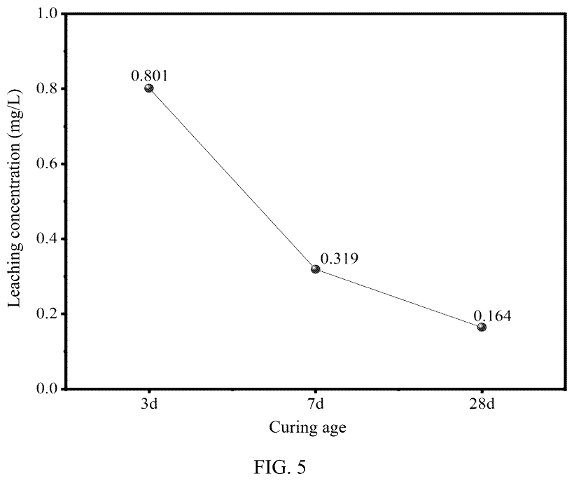

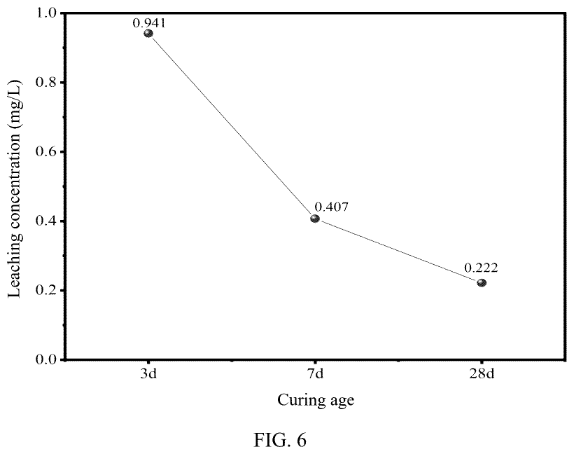

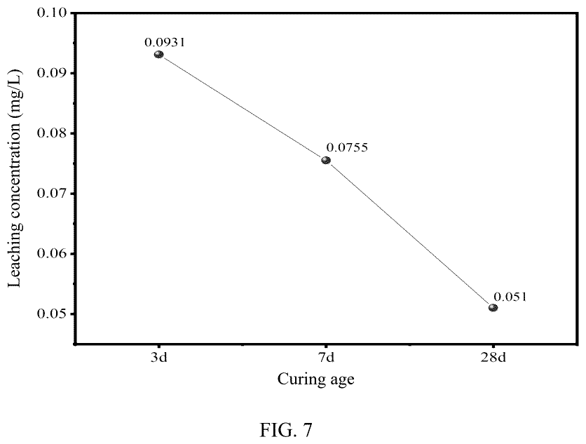

(2) Compressive strength data of the specimens prepared by the adsorption and solidification methods in Example 1-3 are shown in FIG. 2, FIG. 3, and FIG. 4, respectively. According to FIG. 2, FIG. 3, and FIG. 4, it can be seen that as the curing age increases, the strength of the specimens gradually increases. After curing for 3 days, 7 days, and 28 days, the strength can meet construction requirements (greater than 10 MPa).
(3) The leaching concentration is a key indicator to evaluate solidification and stabilization effects of a geopolymer, and a lower value indicates higher solidification capacity and stability of the geopolymer. Leaching concentration data of the specimens prepared by the adsorption and solidification method in Examples 1-3 are shown in FIG. 5, FIG. 6, and FIG. 7, respectively. As shown in FIG. 5, FIG. 6, and FIG. 7, when the adsorption capacity of Pb²⁺ by the carbonized concrete micropowder reaches 200 mg/g, the leaching concentration of Pb²⁺ does not exceed a limit value (Pb<5 mg/L) specified in the “Identification Standard for Hazardous Waste-Leaching Toxicity Identification” (GB5085.3-2007) at any curing age of 3 days, 7 days, or 28 days. Experimental results show that the solidification efficiency of Pb²⁺ exceeds 99%, further verifying that the geopolymer materials have excellent solidification capacity for Pb²⁺ and environmental stability. Since in an alkaline environment, Pb²⁺ may form a hydroxyl-coordinated ion with OH⁻ to generate a heavy metal hydroxide precipitate in a stable state, which is encapsulated within a geopolymer cementitious substance. Furthermore, Pb²⁺ also undergoes ion exchange with Ca²⁺ in ettringite generated in an alkali activation reaction with C-(A)-S-H and gypsum, which is incorporated into a silicate grid and adsorbed by the ettringite. Meanwhile, the formation of a hydration product refines a pore structure of the material and reduces a migration pathway of the heavy metal ion. These factors act together to improve adsorption and solidification capacities for Pb²⁺.

### Comparative Example 1

A wastewater treatment method, also a method for preparing a geopolymer cementitious material, is similar to that in Example 1, with the differences that a solid raw material is obtained by mixing and uniformly stirring slag and carbonized micropowder, where carbonized concrete micropowder accounts for 42%, the slag accounts for 50%, and the remaining 8% of lead nitrate is added in the form of a wastewater solution. The method specifically includes steps as follows.
(1) Cement naturally cured for 7 days was ground in a ball mill to a particle size of less than 125 μm to obtain concrete micropowder, where the concrete micropowder had a CaO content of 48.28%, a SiO₂ content of 15.27%, and an Al₂O₃ content of 4.32%; and then, the concrete micropowder was carbonized under conditions of a humidity of 70±3%, a temperature of 20±2° C., and a carbon dioxide concentration of 20±3% for 7 days, where after the carbonization, the grayish-white concrete micropowder turned into pure gray carbonized concrete micropowder.
(2) Water, NaOH, and sodium silicate were mixed to formulate an alkaline activator with a modulus of 1.2 and a Na₂ content of 5%, followed by standing for 24 hours for later use; the carbonized concrete micropowder prepared in the step (1) and granulated blast furnace slag were added at a ratio of 42%:50% into a cement paste mixer and mixed by stirring to obtain a solid material; lead-containing wastewater was added, and subsequently, the remaining water amount of the alkaline activator was added at a water-cement ratio of 0.4 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

Methods for testing the compressive strength and leaching concentration of the specimen in Comparative Example 1 are the same as those in Example 1.

Comparing Comparative Example 1 with Example 1, when the lead-containing wastewater is directly added in Comparative Example 1, there is no compressive strength at any curing age. This is because after direct addition of Pb(NO₃)₂, Pb²⁺ dissolved out from Pb(NO₃)₂ reacts with sodium silicate and sodium hydroxide in the alkaline activator to generate flocculent products of lead silicate and lead hydroxide, and insoluble precipitates are eventually formed after stirring, thereby reducing the solution alkalinity, severely hindering an alkali activation reaction process, resulting in poor fluidity, and also impeding the dissolution of active Si and Al in a geopolymer precursor material as well as the polymerization of [SiO₄] and [AlO₄]⁻.

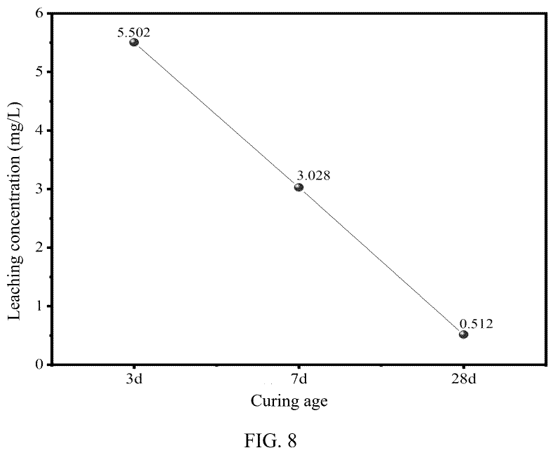

The leaching concentration of Comparative Example 1 is shown in FIG. 8. According to FIG. 8, it can be seen that the leaching concentration of Comparative Example 1 is much higher than that of Example 1, and the leaching concentration of Comparative Example 1 after 3 days is higher than a limit value, while the leaching concentration after 28 days is also much higher than that of Example 1. This difference is mainly attributed to the partial direct dissolution of Pb²⁺, which generates hydroxide precipitates and complexes in an alkaline environment that are prone to re-dissolution under acidic conditions, thereby increasing the leaching amount of Pb²⁺.

### Comparative Example 2

A solid raw material is obtained by mixing and uniformly stirring slag and carbide slag, where the slag accounts for 65%, the carbide slag accounts for 35%, and then, 1.5% of lead nitrate is added in the form of a wastewater solution. Specific steps are as follows.

Water, NaOH, and sodium silicate were mixed to formulate an alkaline activator with a modulus of 1.2 and a Na₂O content of 5%, followed by standing for 24 hours for later use; lead-containing wastewater was added, and subsequently, the remaining water amount of the alkaline activator was added at a water-cement ratio of 0.4 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

The granulated blast furnace slag is S95 grade slag, with main components of CaO (40.03%), SiO₂ (33.58%), and Al₂O₃ (14.59%).

The carbide slag includes main components of CaO (89.5%), SiO₂ (5.17%), and Al₂O₃ (2.99%).

Methods for testing the compressive strength and leaching concentration of the specimen in Comparative Example 2 are the same as those in Example 1.

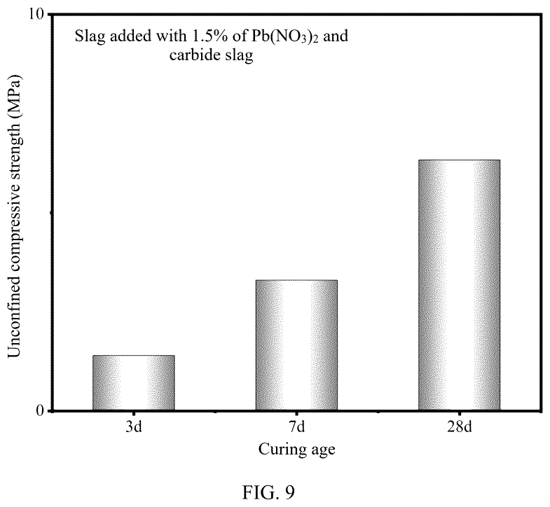

Compressive strength data of the specimen prepared by the adsorption and solidification method in Comparative Example 2 are shown in FIG. 9. According to FIG. 9, it can be seen that as the curing age increases, the strength of the specimen gradually increases. After curing for 3 days, 7 days, and 28 days, the strength cannot meet construction requirements (greater than 10 Mpa). This is mainly because the contents of Al₂O₃ and SiO₂ in the carbide slag are low, resulting in low alkali activation activity. Moreover, after direct addition of Pb(NO₃)₂, Pb²⁺ dissolved out from Pb(NO₃)₂ reacts with sodium silicate and sodium hydroxide in the alkaline activator to generate flocculent products of lead silicate and lead hydroxide, and insoluble precipitates are eventually formed after stirring, thereby reducing the solution alkalinity, severely hindering an alkali activation reaction process, resulting in poor fluidity, and also impeding the dissolution of active Si and Al in a geopolymer precursor material as well as the polymerization of [SiO₄] and [AlO₄]⁻.

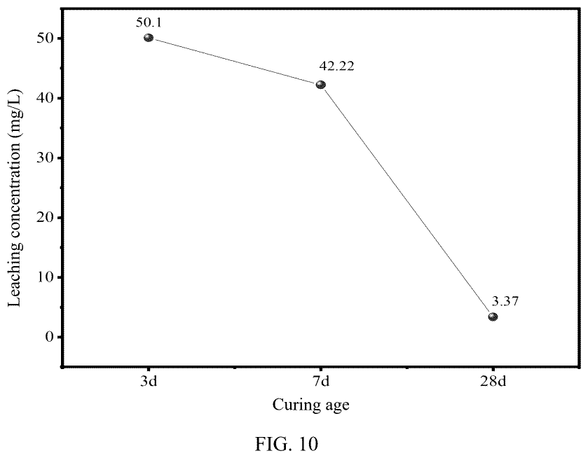

The leaching concentration of Comparative Example 2 is shown in FIG. 10. According to FIG. 10, it can be seen that the leaching concentration of Comparative Example 2 after 3 days and 7 days is much higher than a limit value, and the leaching concentration after 28 days is also much higher than that of Example 1. This difference is mainly attributed to the partial direct dissolution of Pb²⁺, which generates hydroxide precipitates and complexes in an alkaline environment that are prone to re-dissolution under acidic conditions, thereby increasing the leaching amount of Pb²⁺. Furthermore, the low activity of the carbide slag also leads to low compressive strength.

### Comparative Example 3

A geopolymer cementitious material is similar to that in Example 1, with the difference that carbonized micropowder does not adsorb a heavy metal ion.
(1) Concrete micropowder and its carbonization method are the same as those in Example 1.
(2) Water, NaOH, and sodium silicate were mixed to formulate an alkaline activator with a modulus of 1.2 and a Na₂O content of 5%, followed by standing for 24 hours for later use; the carbonized concrete micropowder prepared in the step (1) and granulated blast furnace slag were added in equal weight (50%:50%) into a cement paste mixer and mixed by stirring to obtain a solid material; subsequently, the alkaline activator was added at a water-cement ratio of 0.4 and rapidly stirred for 4 minutes; and a uniformly stirred slurry was poured into a 20×20×20 mm³ six-cavity mold, vibrated on a vibration table for 1 minute, leveled on a surface, allowed to stand and sealed with a plastic wrap for 1 day, then demolded, and cured to a specified age under conditions of a temperature of 20±2° C. and a relative humidity of >95%.

The granulated blast furnace slag is the same as that in Example 1.

Finally, it should be noted that the above examples are only used to illustrate the technical solutions of the present invention and are not intended to limit the scope of protection of the present invention. Although the present invention has been described in detail with reference to preferred examples, those of ordinary skill in the art should understand that modifications or equivalent substitutions to the technical solutions of the present invention can be made without departing from the essence and scope of the technical solutions of the present invention.

What is claimed is:

1. A method for adsorption and immobilization of a heavy metal ion in water, comprising the following steps:
(1) adsorbing a heavy metal ion in water using carbonized micropowder, wherein the carbonized micropowder is obtained by carbonizing concrete micropowder in a carbon dioxide atmosphere, and the concrete micropowder is obtained by grinding hydrated cement; and in percentage by weight, the concrete micropowder has a CaO content of not less than 48.28%, a SiO₂ content of not less than 15.27%, and an Al₂O₃ content of not less than 4.32%;
(2) mixing the carbonized micropowder after adsorbing the heavy metal ion with one or more of granulated blast furnace slag, gypsum, and steel slag to obtain a solid material; and
(3) mixing the solid material with an alkaline activator, followed by curing and molding.

2. The method for adsorption and immobilization of a heavy metal ion in water according to claim 1, wherein the heavy metal ion is one or more of a lead ion, a zinc ion, and a copper ion.

3. The method for adsorption and immobilization of a heavy metal ion in water according to claim 1, wherein the concrete micropowder has a particle size of less than 125 μm.

4. The method for adsorption and immobilization of a heavy metal ion in water according to claim 1, wherein conditions for the carbonizing are as follows: a humidity of 70±3%, a temperature of 20±2° C., a carbon dioxide concentration of 20±3%, and a carbonizing time of 7 days.

5. The method for adsorption and immobilization of a heavy metal ion in water according to claim 1, wherein the granulated blast furnace slag is S95 grade slag with a median particle size D50 of 12.06 μm.

6. The method for adsorption and immobilization of a heavy metal ion in water according to claim 1, wherein a mass proportion of the carbonized micropowder after adsorbing the heavy metal ion in the solid material is 30-70%.

7. The method for adsorption and immobilization of a heavy metal ion in water according to claim 1, wherein the alkaline activator comprises a mixture of a sodium hydroxide solution and sodium silicate, and has a modulus of 1-2 and a Na₂O content of 3-6 wt %.

8. The method for adsorption and immobilization of a heavy metal ion in water according to claim 1, wherein a water-cement ratio of the solid material to the alkaline activator is 0.38-0.45.

9. A geopolymer cementitious material, prepared by the method according to claim 1.
